(19) United States
(12) Patent Application Publication
(10) Pub. No.: US 2011/0270446 A1
(43) Pub. Date: Nov. 3, 2011

(54) SYSTEMS AND METHODS FOR AN ENVIRONMENTAL CONTROL SYSTEM INCLUDING A MOTORIZED VENT COVERING

(75) Inventors: Richard Scharf, Escondido, CA (US); Roger Heald, San Diego, CA (US)

(73) Assignee: ENERGY EYE, INC., Poway, CA (US)

(21) Appl. No.: 12/788,220

(22) Filed: May 26, 2010

Related U.S. Application Data
(63) Continuation-in-part of application No. 12/772,900, filed on May 3, 2010.

(51) Int. Cl. G05D 23/19; G05D 7/06

(52) U.S. Cl. 700/282; 700/300; 700/277

(57) ABSTRACT

A motorized vent covering for an air vent of the environment control system, the motorized vent covering comprising an air flow restrictor for controlling air flow through the vent; and an actuator, the actuator including a motor configured to drive the air flow restrictor to control the flow of air from the vent, and a controller in communication with the motor, the controller configured to provide operating instructions to the motor to open or close the air flow restrictor to adjust the flow of air through the air vent.

### RELATED APPLICATIONS

This application claims priority as a continuation-in-part under 35 U.S.C. §120 to copending U.S. patent application Ser. No. 12/772,900 entitled “SYSTEMS AND METHODS FOR A MOTORIZED VENT COVERING IN AN ENVIRONMENT CONTROL SYSTEM,” filed on May 3, 2010, which is incorporated herein by reference in its entirety.

### BACKGROUND

1. Technical Field

The embodiments described herein are related to automated environment control system operation and more particularly, to systems and methods for controlling the operation of a motorized vents in an environment control system.

2. Related Art

Heating, ventilating, and air conditioning (HVAC) systems provide control over the indoor environment of buildings through heating, cooling, and air circulation. Rising energy costs have driven manufacturers to make an effort to make these systems more energy efficient; however, even the most energy efficient HVAC systems can still waste energy by heating or cooling unoccupied spaces within a building. For example, in a multi-story home, occupants may be downstairs during the day and move upstairs at night. Accordingly, it can be inefficient and costly to heat or cool the upstairs during the day and the downstairs at night.

Conventional HVAC systems have a central heating and cooling unit that pushes air into various rooms through ducts with outlets in the rooms. The outlets are typically covered by a vent covering that includes adjustable louvers. Accordingly, one could adjust the louvers to make heating and cooling more efficient, but this is time consuming and often difficult due to the location of the vent coverings.

Other multi-room buildings can also suffer from similar inefficiencies. For example, suites or other multi-room facilities in hotels can have multiple rooms or outlets controlled by a single heating and air conditioning unit. Office buildings also often have multiple offices or rooms controlled by a single unit.

Conventional HVAC systems do not provide the ability to control the flow of air such that it only goes to occupied portions of the building, or where it is needed.

### SUMMARY

Systems and methods for an environment control system that includes a motorized vent covering configured to control the air flow into and/or out of a room through a vent are described herein.

In one aspect, an environment control system for controlling the lighting and temperature of a room is provided. The environment control system includes a daylight sensor for detecting light propagating into the room, and a control system. The control system is in communication with the daylight sensor, and, the control system is configured to control the temperature of the room based at least in part on signals received from the daylight sensor. According to some aspects, the environment control system can be configured to controlling the lighting and temperature of a plurality of rooms of a multi-room building.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an example motorized vent covering in accordance with one embodiment;

FIG. 2 is a diagram illustrating an example actuator for use in the motorized vent covering of FIG. 1;

FIG. 3 is a flow chart illustrating an example process for upgrading a room to include the motorized vent covering of FIG. 1; and

FIG. 4 is a diagram illustrating an example environment control system that can include the motorized vent covering of FIG. 1 in accordance with one embodiment.

### DETAILED DESCRIPTION

The following detailed description is directed to certain specific embodiments. However, it will be understood that these embodiments are by way of example only and should not be seen as limiting the systems and methods described herein to the specific embodiments, architectures, etc. In this description, reference is made to the drawings wherein like parts are designated with like numerals throughout.

The systems and methods disclosed herein provide an environment control system that includes a motorized vent covering that can be configured to control the flow or air into or out of a room through a vent. Rooms can include multiple vents that have motorized vent coverings. A motorized vent covering can include an air flow restrictor that can be opened and/or closed to control the air flow into or out of a room through the vent. The environment control system can be configured to automatically control the airflow into and/or out of rooms in order to more efficiently heat, cool, and/or ventilate the building, e.g., by only moving air into and/or out of rooms that are occupied. As a result, the HVAC systems can operate more efficiently by reducing energy usage and reducing utility costs.

According to some embodiments, the environment control system can be configured for use with a shared HVAC system that provides heating, cooling, and/or ventilation system to multiple rooms. For example, in an office building, a single HVAC system can provide HVAC services to several offices. In another example, a hotel can include multiple room suites or villas that have a single HVAC system that provides HVAC services to multiple rooms. In yet another example, a residence can include a single HVAC system that provides HVAC services to multiple rooms in the residence.

According to some embodiments, the environment control system can include a controller that is configured to receive data from environment sensors in the room or rooms and to control heating and cooling based on information received from the sensors. For example, the environment control system can use the data from the sensors to determine whether to activate a motor coupled to a motorized vent to open or close the vent in order to allow or restrict air flow through the vent. The environment control system can be configured to receive and process data from various different types of environment sensors, such as motion sensors and presence detectors to detect when an occupant is in a room, temperature sensors for detecting the temperature in a room, and/or light sensors for detecting the amount of light entering windows of a room. The environment control system can also be configured to receive and process data from other types of sensors that provide information about the environment in a room. Such embodiments are discussed in more detail below.

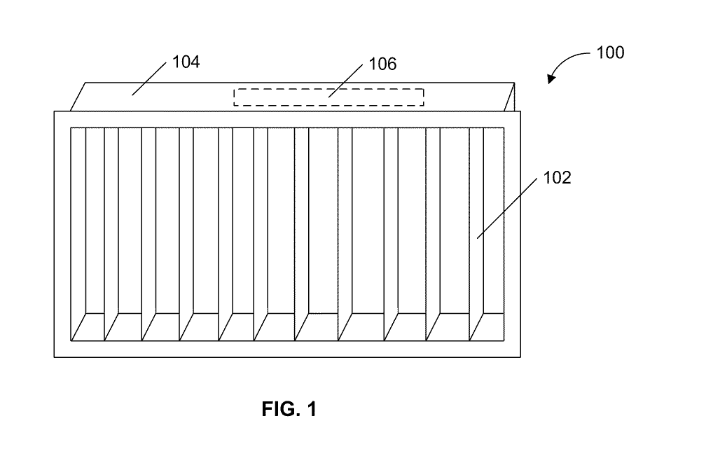

FIG. 1 illustrates an example motorized vent covering 100. The motorized vent covering 100 comprises a frame 104 and covers the outflow of a HVAC vent (not shown) through which air from, e.g., a forced air heating and/or cooling system can enter the room. The motorized vent covering 100 can include a means for at least partially restricting and/or stopping the airflow from the forced air heating and/or cooling systems from entering the room. According to one embodiment, the HVAC system is a central HVAC system that provides heating or cooling to a residence or building or a portion thereof. The HVAC system can distribute heated or cooled air through supply ductwork installed in the building. Heated or cooled air can be distributed from the supply ducts and into rooms of the residence or building from vents installed in the ducts.

The motorized vent covering 100 can include an airflow restrictor for controlling air flow through the vent upon which the motorized vent covering 100 is mounted. In an embodiment, the air flow restrictor of the motorized vent covering 100 can comprise a set of louvers 102 that can be opened or closed to control the air flow from the vent into the room. According to another embodiment, the air flow restrictor of the motorized vent covering 100 can comprise a damper that can be opened or closed to control air flow from the vent. According to another embodiment, the motorized vent covering 100 can include pivotable louvers that can be configured to direct air flow from the vent in various the directions by pivoting the louvers.

According to some embodiments, an actuator 106 can be integrated into the frame 104 of motorized vent covering 100. In yet other embodiments, an existing non-motorized vent covering can be retrofitted with an actuator 106 to control the operation of the vent covering 100.

Actuator 106 can be configured to open or close the airflow restrictor. In embodiments where the environment control system includes multiple motorized vent coverings 100, each motorized vent covering 100 can include an actuator 106 for opening and closing the airflow restrictor of the motorized vent covering 100. According to an embodiment, the airflow restrictor can comprise a set of louvers, and the actuator 106 can be configured to actuate a shaft that is interfaced with a rod arm associated with one of the plurality of louvers 102 used to control the air flow from the motorized vent covering 100 and thereby activate all of the plurality of louvers 102 simultaneously via a linking apparatus that allows the louvers to be operated simultaneously.

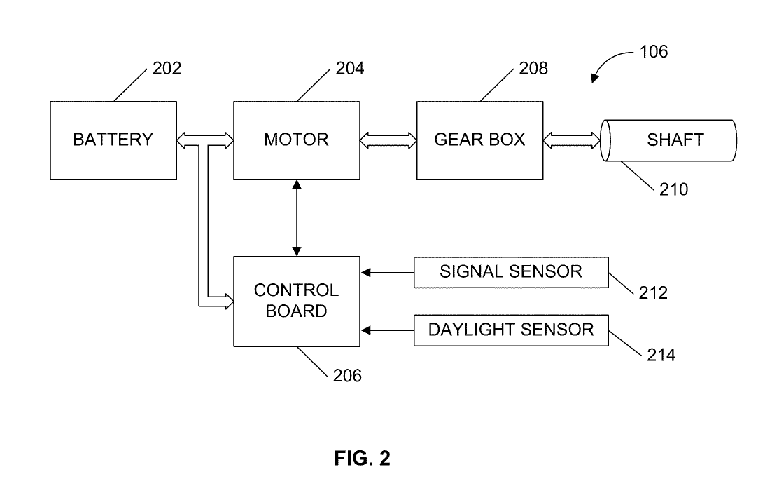

FIG. 2 is a diagram illustrating an example actuator 106 in block form and in accordance with one embodiment. As can be seen, actuator 106 can comprise a power source such as rechargeable or non-rechargeable batteries 202 configured to supply power to a motor 204 and control board 206. Control board 206 can be a circuit board and can include circuits, such as a microprocessor (not shown) for controlling the operation of actuator 106. For example, the circuits on control board 206 can be configured to activate and deactivate motor 204. Motor 204 can be interface with gear box 208, which can be configured to activate a shaft 210 that in turn can be interface with a mechanism that controls the position of, e.g. louvers 102.

Actuator 106 can also include a sensor 212 coupled with control box 206 and configured to receive command signals for operating actuator 106. In this way, actuator 106 can be controlled via remote control, allowing for easy operation of motorized vent covering 100. Sensor 212 can be configured to receive radio frequency or optical, e.g., Infrared, command signals.

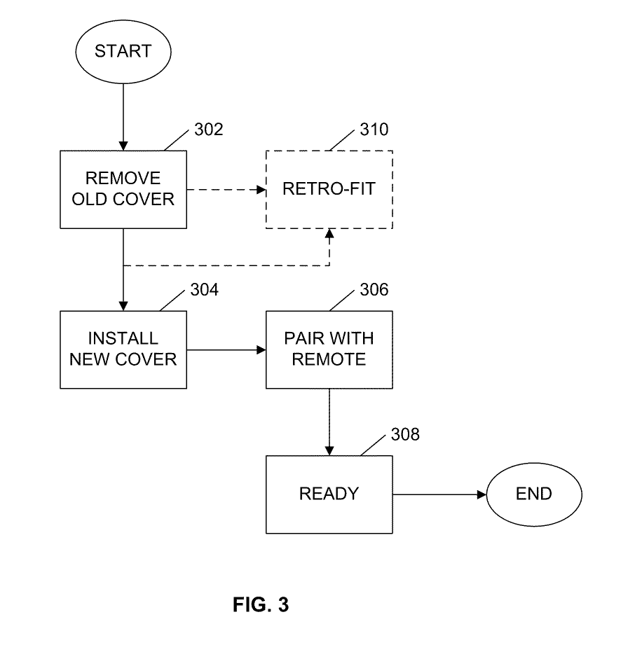

Often some configuration is required in order to pair actuator 106 with an applicable remote and to calibrate the operation of, e.g., louvers 102. FIG. 3 is a flow chart illustrating the installation and configuration of a motorized vent covering 100. First, in step 302 the old vent covering is removed. Then, in step 304, a motorized vent covering 100 is installed in place of the old vent covering. Then in step 306, a remote control is paired with the automated vent covering 100 causing any calibration operations for actuator 106 to take place. The automated vent covering 100 is then ready for operation under the control of the remote in step 308.

Accordingly, if a home owner replaced all of the vents in his house with automated vent coverings 100, then the owner can use the remote to close vents upstairs during the day and open them at night. The owner can also open vents downstairs during the day and close them at night. This can allow for more efficient and less costly heating and air conditioning of the house. The same principles can be used to control heating and cooling in any multi-room, or multi-vent building including hotel rooms, meeting rooms, office buildings, etc.

For example, the systems and methods described can be used in a multiple room unit, such as a suite, where the multiple room unit has a dedicated HVAC system. The automated vent covering 100 can be used to control air flow into and out of rooms based in part on the occupancy by closing vents at least part of the time in unoccupied rooms of the multiple room unit in order to save energy and reduce utility bills.

In another example, the automated vent covering 100 can be configured for use with multiple offices in an office building that share an HVAC system. In many office buildings, several offices can share an HVAC system that provides heating, cooling, and/or ventilation to each of the offices. In a typical configuration, one of the offices includes a thermostat for selecting a temperature at which the HVAC system will attempt to maintain the offices that share the HVAC system. This configuration can lead to discomfort and disagreements between occupants of these offices if the occupants cannot reach a consensus on as to what is a comfortable temperature. A temperature that one occupant finds comfortable may be too hot or too cold for an occupant of another office.

The automated vent covering 100 can be configured to allow occupants of an office to adjust the airflow from the HVAC system into and/or out of their office. For example, an occupant that was overheated could instruct the automated vent covering 100 to close the motorized vent covers in her office to divert heat from the HVAC system away from her office. Similarly, if the occupant was cold, she could instruct the automated vent covering 100 to close the motorized vent covers in her office to divert cool air from the HVAC system away from her office. For example, the environment control system can include a remote control that sends a signal instructing the automated vent covering 100 to close the motorized vents in the room.

As mentioned, in certain embodiments, actuator 106 can be included in a kit for retro-fitting existing vents. Thus, the process of FIG. 3 may include a step of retrofitting the vent in step 310. Such a kit can include brackets and mounting hardware for mounting actuator 106 in frame 104 and linking hardware for linking shaft 210 with, e.g., louvers 102 and possible linking louvers 102.

Use of batteries and the ability for remote operation, allows a conventional, non-motorized vent covering of an existing HVAC system to be replaced with motorized vent covering 100 without requiring the installation of wires to deliver a control signal or power to actuator 106 or requiring manual operation of the motorized vent covering 100. It should be noted that in accordance with some embodiments, the environment control system can include a manual override that allows an occupant of a room to override the system in order to manually adjust the air flow through the vent.

In other embodiments, as described below, actuator 106 can be coupled with environmental sensors, such that it operates in response to, e.g., changing light conditions, increasing the automation of motorized vent covering 100. For example, a daylight sensor 214 can be included in or coupled to actuator 106 to allow remote operation and or automated operation based on daylight conditions. For example, the daylight sensor 214 can be configured to generate a signal to cause the actuator 106 to open, e.g., louvers 102 during daylight hours in order to provide HVAC services to a particular room. Such a configuration can be desirable in an office building where the room is an office that is typically occupied during daylight hours. The daylight sensor can thus cause the HVAC services to be directed into the office during daylight hours.

Inclusion of a daylight sensor can require configuration of the sensor or actuator 106 in order to dictate what actions to take in response to a signal from the daylight sensor 214, e.g., should the louvers open, close, open a little, close a little, etc.

Similarly, a time of day sensor, such as a clock can be include in or interfaced with actuator 106 in order to allow automated control of the air flow based on the time of day. Again, this can take some configuration in order to provide the proper control at the proper time of day.

Thus, the motorized vent covering 100 can be configured to close vents in one or more rooms based on time of day, occupancy, temperature, and/or other factors. For example, the motorized vent covering 100 can be configured to reduce the airflow through the motorized vents in the bedrooms of a home during the day when the bedrooms are likely to be unoccupied. The motorized vent covering 100 can also be configured to open the motorized vents of the bedrooms at night when the bedrooms are likely to be occupied and to close the motorized vents or reduce the airflow through the motorized vents in rooms, such as the living room, dining room, and kitchen, that are not as likely to be occupied to during the night. As a result, less energy should be required to operate the HVAC system to heat or cool parts of the residence that not likely to be occupied.

In certain embodiments, motorized vent covering 100 can be integrated into a larger environmental control system. Such a system, for example, can be configured to control the position of window coverings, the operation of the HVAC system, operation of lighting, etc.

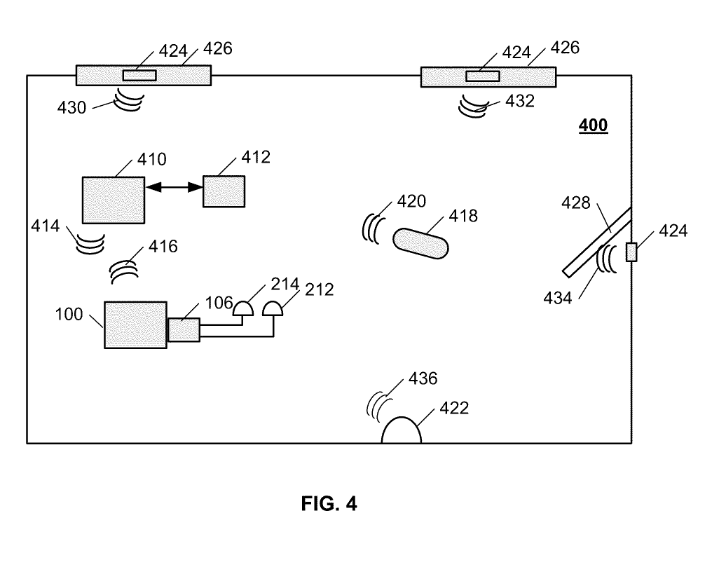

For example, FIG. 4 illustrates an example environment control system 400 that includes a motorized vent covering 100 according to an embodiment. In the embodiment illustrated in FIG. 4, the environment control system 400 is configured to control a single room; however, it will be apparent that system 400 can be configured to provide coordinated environmental control for multiple rooms within a building.

System 400 comprises a controller 410, which can include a processor or controller as well as the components, hardware and software; sensors; data storage; etc., needed to control, e.g., lighting, temperature, etc., within the room. Controller 410 can be interfaced wired or wirelessly with a temperature sensor 412, which can provide temperature information to controller 410. For example, temperature sensor 412 can be included in a thermostat. In addition, system 400 can include a presence detector 422 configured to detect the presence of someone in the room as well as motion sensors 424 interfaced with windows 426 and door 428. Sensors 424 can be configured to detect whether windows 426 or door 428 have been opened or closed.

Motorized vent covering 100 can include frame 104, actuator 106, and sensors 212 and 214 coupled with actuator 106, which can be configured to operate in response to information provided by sensors 212 and 214. Thus, for example, a remote control 418 can be configured to provide control signals 420 to signal sensor 212 to thereby control the operation of actuator 106, or more specifically the position of the louvers 102 of the motorized vent covering 100.

Signals 420 can be optical control signals or radio signals depending on the embodiment.

Additionally, actuator 106 can be in communication via signals 414 and 416 with a controller 410. Actuator 106 can, therefore, be coupled with a communications module (not shown) configured to generate signals 416 and/or receive signals 414. Signals 414 and 416 can be optical or radio signals. Thus, the communication module can be configured to generate and/or receive the appropriate type of signal. It will be understood that actuator 106, sensors 212 and 214, and/or the communications module can be included in a single housing or as separate units depending on the embodiment.

Daylight sensor 214 can then be communicatively coupled with controller 410, either directly or via actuator 106, or more specifically the communications module. Similarly, any, all, or a combination of a temperature sensor 412, motion sensors 424, daylight sensor 214, sensor 212, and presence detector 422 can be communicatively coupled with controller 410 either via a wired or wireless interface. In the example of FIG. 4, temperature sensor 412 is shown as being connected via a wired connection with controller 410, while motion detectors 424 and presence detector 422 are illustrated as being coupled with controller 410 via wireless communication signals 430, 432, 434, and 436. Again, signals 430, 432, 434, and 436 can be optical or radio signals depending on the embodiment.

As noted, the temperature sensor 412 can be included in a programmable thermostat. The programmable thermostat can provide a user interface that allows the building management and/or the room occupants to set a preferred temperature for the room in which the thermostat is installed. The programmable thermostat can be configured to control the HVAC operation. In addition, the thermostat can be configured to generate a signal that causes controller 410 to take control of the HVAC operation, e.g., when the room is unoccupied and if the temperature of the room falls below or rises above the preferred temperature. In an embodiment, the programmable thermostat can be programmed with a preferred temperature range for the room that includes an upper and lower threshold, or a table(s) of upper and lower threshold pairs.

Thus, the programmable thermostat can be programmed with a preferred temperature range for when the room is occupied and a preferred temperature range when the room is unoccupied. As a result, the temperature of the room can be maintained within a first temperature range when the room is occupied and within a second temperature range when the room is unoccupied in order to conserve energy.

In some embodiments, the temperature sensor 412 can comprise a programmable thermostat that controls the temperature of multiple rooms of a building. In one example, multiple offices in an office building share the same HVAC unit and the programmable thermostat is located in one of the office. The occupant of the office in which the programmable thermostat is located can control the temperature of the offices that share the HVAC unit by setting a preferred temperature or temperature range on the programmable thermostat, which controls the HVAC. The occupant of an office that does not include the programmable thermostat can still exercise some control over the temperature within the office by instructing the motorized vent covering 100 in their office to adjust the air flow in their office. For example, the occupant can instruct the motorized vent covering 100 to open and/or close the vents in his or her office using remote control 418.

In one embodiment, the remote control 418 can be a wall-mounted device that includes controls that allow the occupant of the office to instruct the motorized vent covering 100 to adjust the air flow. Not only does this allow the occupant of an office that does not include a programmable thermostat to exercise some control over the temperature within their office, this can also conserve energy by only using the HVAC to heat and cool those offices where the HVAC services are desired.

Returning now to FIG. 4, motion detectors 424 can be configured to detect the status of windows 426 and door 428, e.g., in order to detect whether someone has entered the room or whether one of the windows or door is open. Presence detector 422 can be configured to detect whether an individual is in the room.

Controller 410 can then be configured to control the operation of the HVAC, actuator 106, or both based on the inputs from the various systems. This control can be part of a larger control program to control the environment, e.g., lighting and temperature within the room and/or within multiple rooms of a multiple room building. For example, controller 410 can be configured to control the HVAC operation to adjust the temperature of the room to fall within a first preferred range if an occupant is detected in the room by motion detectors 424 and/or presence detector 422. The controller 410 can also be configured to control the HVAC operation to adjust the temperature of the room to fall within a second preferred range when no occupant is detected within the room. For example, if no occupant is detected in the room for at least five minutes, the controller 410 can be configured to maintain the room temperature at the second preferred range. In an embodiment, the length of time for determining when to switch to the second preferred temperature range can be configured by the building administrator.

For example, controller 410 can also be configured to control the temperature in the room in part by controlling the position of window coverings on the windows 426, actuator 106, lighting, and HVAC operation, or some combination thereof based on the time of day, amount of light entering the room or incident on one of windows 426, the temperature, or some combination thereof. In an embodiment, the windows can have window coverings, such as shades, blinds, or curtains, and the window coverings can comprise a motor that can be controlled by controller 410 to open or close the window coverings to control the amount of light entering the room.

In an embodiment, the controller 410 can be configured to monitor the temperature of a room to keep the temperature of the room within a preferred temperature range while the room is unoccupied. If the temperature of the room rises above the preferred range, the controller 410 can be configured to operate the HVAC, open motorized vent covering 100, or both to allow cooled air from the HVAC system into the room. Thus, the temperature of the room can be maintained within a range where that can easily be heated or cooled to a comfortable temperature when an occupant enters the room.

According to an embodiment, the controller 410 can include a manual override that allows an occupant to override the current system settings. According to an embodiment, the temperature sensor 412 can be a programmable thermostat, and the room occupant can override the current settings for the room by adjusting the temperature on the programmable thermostat. As a result of the occupant's override, the operation of the HVAC, motorized vent coverings 100, or both can be controlled to adjust the temperature and/or air flow into the room according to the occupant's preferences.

In certain embodiments, if the occupant leaves, as determined by motion detectors 424 and presence detector 422, then the operation of the HVAC can be controlled in a manner so as to achieve energy savings. For example, if a motion detector 424 detects that an entry such as a door has been opened, then presence detector 422 can be configured to start searching for an occupant. If an occupant is detected, then control of the HVAC, and possibly actuator 106 if include, can be maintained, e.g., according the occupant's preference as indicated via thermostat 412. But if no occupant is detected by presence detector 422, e.g., within a set time period, then energy saving s control can be implemented.

The energy savings can be achieved via a control algorithm, e.g., implemented by controller 410 that uses time periods or cycles that are keyed based on certain temperature thresholds. For example, when the room is unoccupied and energy savings control is initiated, controller 410 can be configured to turn the HVAC off until a maximum temperature threshold is reached. The HVAC can then be turned on again for a certain period of time in order to drive the temperature in the room back toward a setpoint. After the period of time has run, then the temperature can be checked to determine if is moving toward the set point. If the temperature is moving toward but has not reached the set point, then the HVAC can be run for an additional period of time. At the conclusion of this period of time, the HVAC can be turned of again and the process repeated.

According to another embodiment, the associated motion detector 424 and/or presence detector 422 can be used to override the current settings for a room if an occupant is detected in the room. For example, if a classroom is being used for an event that is scheduled outside of regular operating hours when the environment control system would typically turn off heating and cooling to the classroom, the system can be configured to override the programming and provided heating and cooling to the room if the associated motion detector 424 and/or presence detector 422 detect that the room is occupied.

Further, upon detection that the occupant has left, controller 410 can be configured to control HVAC, e.g., as described above or to control, e.g., actuator 106 and the motorized vent covering 100 to limit heated or cooled air from entering the room when no one is in the room. This can, for example, lower heating and/or cooling costs by redirecting air conditioned air away from the room when the room is unoccupied so that the heated or cooled air can be redirected to occupied portions of the building where the heated or cooled air is needed.

According to some embodiments, the room can include multiple vents that each comprises a motorized vent covering 100. For example, in one embodiment, a room may have a vent located near the floor and a vent located near the ceiling and both vents have a motorized vent covering 100 mounted thereon. In an embodiment, when the HVAC system is heating the room, the motorized vent covering 100 of the vent located near the ceiling can be closed and the motorized vent covering 100 of the vent located near the floor can be opened. This would allow the warm air produced by the HVAC system to enter the room near the floor and rise toward the ceiling in order to heat the room. For example, the controller 410 can be configured to generate a control signal to cause the actuator 106 of the motorized vent covering 100 of the vent located near the ceiling to close the air flow restrictor of the motorized vent covering 100, and the controller 410 can be configured to generate a control signal to cause the actuator 106 of the motorized vent covering 100 of the vent located near the floor to open the air flow restrictor of the motorized vent covering 100.

When the HVAC system is cooling the room with cool air, the motorized vent covering 100 of the vent located near the floor can be closed and the motorized vent covering 100 of the vent located near the ceiling can be opened. This would allow the cool air produced by the HVAC system to enter the room near the ceiling and fall toward the ceiling in order to heat the room. For example, the controller 410 can be configured to generate a control signal to cause the actuator 106 of the motorized vent covering 100 of the vent located near the ceiling to close the air flow restrictor of the motorized vent covering 100, and the controller 410 can be configured to generate a control signal to cause the actuator 106 of the motorized vent covering 100 of the vent located near the floor to open the air flow restrictor of the motorized vent covering 100. As a result, the room can more effectively been heated or cooled by forcing air conditioned air into the upper or lower portion of the room where the air conditioned air can have the most impact on the temperature of the room.

It will be understood that a variety of heating, cooling, lighting, etc., control programs can be implemented by controller 410 based on the various inputs to controller 410 and based at least in part by control of actuator 106. It will also be understood that controller 410 can also be interfaced with not only with a heating and cooling system as described above but can also be interface with an artificial lighting system to control such systems based on the various sensor inputs. For example, if the motion detector at the door detects that an occupant has entered a room, a light or lights in the room may be turned on and vents in the room opened to allow the HVAC system to heat or cool the room.

In an embodiment, the controller 410 and/or the programmable thermostat 412 can receive control signals from a central control computer system (not shown). The central control computer system can be configured to allow a building administrator to define environmental control settings for one or more rooms in a multi-room building, such as a hotel or office building. This would allow the building administrator to develop a comprehensive HVAC plan for the building, where occupancy, sensor data, and other considerations such as time of day and/or date could be used to control which parts of the building are heated or cooled and which parts of the building should not receive HVAC services. For example, in some embodiments, the environment control system 400 can be installed in a residence, and the central control system can be a personal computer system such as a laptop computer that can be configured to interface with the environment control system 400 via a wired or a wireless connection. A user can configure the environment control system 400 to adjust the airflow and temperature in various parts of the residence based on various parameters, such as time of day, temperature, and/or other parameters based on sensor data received from the environment sensors and/or via other sources.

According to an embodiment, the controller 410 can provide for variable temperature control of a room based on the signal data received from daylight sensor 214. For example, the controller 410 can control the HVAC or signal the motorized vent coverings 100 to open or close the vents in the room based on whether the room is in direct sunlight. In an embodiment, the controller 410 can also use signal data received from other sensors in addition to the daylight sensor 214 and take actions to control the temperature in the room. For example, the controller 410 can make a determination whether the room is occupied using the signal data received from presence detector 422 and motion sensors 424, and close the curtains, blinds, or other window treatments to the room if the room is unoccupied and the daylight sensor 214 indicates that the room is in direct sunlight. In an embodiment, the controller 410 can also determine whether to signal the motorized vent coverings 100 to open or close the vents in the room based on whether the room is in direct sunlight and signals received from temperature sensor 412. In an embodiment, the controller 410 can also be configured to turn off or dim the lights to a room if the daylight sensor 214 indicates that the room is receiving direct sunlight. In some embodiments, the controller 410 can turn off the lights to the room to conserve power and to reduce excess heat in the room in order to control the temperature of the room. And in certain embodiments, the controller can of course control the temperature more directly by controlling the operation of the HVAC system. For example, the temperature thresholds or time periods used during the energy conservation operation described above can be altered based on how much direct sunlight is entering the room.

Thus, it will be understood that some or all of the above mechanisms, i.e., window coverings, vents, lighting, and HVAC system can be controlled based on some combination of inputs from the motion sensor, presence detector, light sensor, temperature sensor, and time of day detector.

As described above, a central control computer system can be configured to allow a building administrator to define environmental control settings for one or more rooms in a multi-room building, such as a hotel or office building. In one embodiment, individual rooms can include a control system 410 interfaced with the central computer system, and configured to provide data received from various sensors in the room to the central computer system and to receive commands from the central computer system to perform various actions, such as turning off lights, signaling motored vent covers 100 to open or close, opening or closing window treatments, turning a HVAC system on or off, or a combination thereof in order to control the temperature and other conditions within the rooms.

According to an embodiment, a manager or administrator of a building can create a comprehensive HVAC plan for controlling the temperatures throughout a building. In one embodiment, the building can be divided up into sections or sectors, and different heating and cooling settings can be associated with each of these sectors. For example, comprehensive plan can be created based on the amount of sunlight that different parts of the building receive throughout the day. Signal data received from the sunlight sensors 214 located in a sector can be used to determine the amount of sunlight that is being received by rooms in that sector. The comprehensive plan can be based on the time of day, the season, and inside and outside air temperatures. In some embodiments, a time of day sensor can provide signal data to the central controller to indicate the current time and a date sensor can provide data to the central controller to provide the date. In some embodiments, different heating and cooling parameters can be associated with specific dates, e.g., limited heating and/or cooling on weekends and public holidays in an office building, or based on the season.

In one example, an office building could be divided into north-east, north-west, south-east, and south-west sectors where each sector can have different heating and cooling parameters associate with that sector. The south-east sector of the building may tend to receive the most direct sunlight in the morning, while the north-west sector of the building receives the least direct sunlight. The central controller can signal controllers 410 located in rooms to adjust HVAC operation to control the airflow through motorized vent covers 100 located in the rooms, to adjust the position of window coverings in those rooms, or take other actions to control the temperature in those rooms, or a combination thereof. For example, the central controller can signal the controllers 410 in the south-east sector of the building to adjust the flow of air through the motorized vent covers 100 in order to decrease the flow of heat that enters rooms in the south-east sector of the building receive in the morning and increase the flow of heated that rooms in the north-west sector of the building receive in the morning. Similarly, the central controller can signal the controllers 410 in the south-east sector of the building to adjust the flow of air through the motorized vent covers 100 in order to increase the flow of cold air that rooms in the north-east sector of the building receive in the afternoon and decrease the flow of cold air that rooms in the north-east sector of the building receive in the afternoon when the south-west sector of the building receives the most direct sunlight is indicated, e.g., by the sunlight sensors.

In other embodiments, such control can be implemented locally by controller 410 without incorporating a central controller.

The central controller or controllers 410 can take into account the amount of direct sunlight impacting the sunlight sensors 214 when determining which actions should be taken to control the temperature in the various sectors of the building. For example, on a cloudy day where there is less direct sunlight, the south-east sector of the building might require less air conditioning than on a bright and sunny day. For example, a central controller, or controllers 410, can be configured to use temperature thresholds, on/off time periods, or both to control the temperature when the various rooms in a building are unoccupied. These thresholds, time periods, or both can be modified based on how much sunlight is actually hitting a particular room or section of a building.

According to an embodiment, existing non-motorized vent covers for a HVAC system can be retrofitted with a motor, such as actuator 106 described above, and the actuator 106 can be controlled via controller 410, using a remote control, such as remote control 418 described above, and/or through various methods described in the various embodiments disclosed here. For example, conventional non-motorized vent covers in a residence can be modified to include a motor that can operate the vent covers to open and close the vent covers in accordance with the various embodiments described above. In one embodiment, the retrofitted vent covers may include a sensor coupled to the actuator 106 for receiving signals from a remote control 418, and the remote control 418 is configured to generate signals that allows the user to selectively open and or close the retrofitted vent covers. The sensor can receive signals from the remote control 418 and activate the motor to open, close, or partially open or close the retrofitted vent cover. In another example, a conventional non-motorized vent in an office can be retrofitted to include a actuator 106 and a sensor coupled to the actuator 106 for receiving signals from a remote control 418, and the remote control 418 is configured to generate signals that allows an occupant of the office to selectively open and or close the retrofitted vent cover using the remote.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. An environment control system for controlling the environmental conditions in a multi-room building via an electrical appliance, the system comprising:
a plurality of daylight sensors for detecting light propagating into various rooms of the multi-room building;
a control system in communication with the plurality of daylight sensors and the electrical appliance, the control system configured to control the environmental conditions in different rooms within the multi-room building by controlling the electrical appliance when the room is unoccupied based at least in part on signals received from the plurality of daylight sensors and based on a series of time cycles during which the electrical appliance is turned on or off as dictated by a plurality of temperature thresholds.

2. The environment control system of claim 1, wherein the temperature thresholds are different for different rooms in the multi-room building based on the signals received from the plurality of daylight sensors.

3. The environment control system of claim 1, wherein the time cycles are different for different rooms in the multi-room building based on the signals received from the plurality of daylight sensors.

4. The environment control system of claim 1, wherein a plurality of the rooms in the multi-room building comprise a motion sensor for determining whether someone has entered or left the room and a presence detector for determining whether the room is occupied, and wherein the control system is configured to control the environmental conditions in the plurality of rooms based on information provided by the motion and presence sensors.

5. The environment control system of claim 4, wherein the electrical appliance is a heating and cooling system.

6. The environment control system of claim 1, wherein the electrical appliance is a motorized vent covering for controlling air flow through an air vent.

7. The environmental control system of claim 6, wherein the motorized vent covering comprises:
an air flow restrictor for controlling air flow through the vent; and
an actuator, the actuator including
a motor configured to drive the air flow restrictor to control the flow of air from the vent;
wherein the actuator is configured to receive operating instructions from the control system to open or close the air flow restrictor to adjust the flow of air through the air vent.

8. The environment control system of claim 7, wherein the air flow restrictor comprises a plurality of louvers, and wherein the actuator further comprises a shaft coupled with the motor and configured to drive the plurality of louvers.

9. The environment control system of claim 1, wherein the electrical appliance is a motorized window covering.

10. The environment control system of claim 5, wherein the plurality of rooms are divided into sectors, wherein the environmental control system is configured to associate different heating and cooling parameters with each sector of the building based on signals received from the plurality of daylight sensors.

11. The environment control system of claim 10, wherein environment control system is configured to control the temperature of each sector based on sensor data received from the daylight sensor of each room.

12. The environment control system of claim 5, wherein the control system is in communication with a temperature sensor, and wherein the control system is configured to control the temperature of the room based at least in part on signals received from the temperature sensor.

13. The environment control system of claim 1 wherein the control system is in communication with a time of day sensor, and wherein the control system is configured to control the environmental conditions based at least in part on signals received from the time of day sensor.

14. The environment control system of claim 1, wherein the control system comprises a plurality of local control systems in each of the rooms of the multi-room building.

15. An environment control system for controlling the temperature in a multi-room building, the system comprising:
a heating and cooling system configured to control the temperature in various rooms of the multi-room building;
a plurality of daylight sensors for detecting light propagating into various rooms of the multi-room building;
a control system in communication with the plurality of daylight sensors and the heating and cooling system, the control system configured to control the temperature in different rooms within the multi-room building by controlling the heating and cooling system when the room is unoccupied based at least in part on signals received from the plurality of daylight sensors and based on a series of time cycles during which the heating and cooling system is turned on or off as dictated by a plurality of temperature thresholds.

16. The environment control system of claim 15, wherein the temperature thresholds are different for different rooms in the multi-room building based on the signals received from the plurality of daylight sensors.

17. The environment control system of claim 15, wherein the time cycles are different for different rooms in the multi-room building based on the signals received from the plurality of daylight sensors.

18. The environment control system of claim 15, wherein a plurality of the rooms in the multi-room building comprise a motion sensor for determining whether someone has entered or left the room and a presence detector for determining whether the room is occupied, and wherein the control system is configured to control the temperature in the presence sensors.

19. The environmental control system of claim 15, further comprising a motorized vent covering, the motorized vent covering including:
an air flow restrictor for controlling air flow through the vent; and
an actuator, the actuator including
a motor configured to drive the air flow restrictor to control the flow of air from the vent;
wherein the actuator is configured to receive operating instructions from the control system to open or close the air flow restrictor to adjust the flow of air through the air vent.

20. The environment control system of claim 19, wherein the air flow restrictor comprises a plurality of louvers, and wherein the actuator further comprises a shaft coupled with the motor and configured to drive the plurality of louvers.

21. The environment control system of claim 15, wherein the plurality of rooms are divided into sectors, wherein the environmental control system is configured to associate different heating and cooling the plurality of daylight sensors.

22. The environment control system of claim 15, wherein the control system is in communication with a time of day sensor, and wherein the control system is configured to control the environmental conditions based at least in part on signals received from the time of day sensor.

23. The environment control system of claim 15, wherein the control system comprises a plurality of local control systems in each of the rooms of the multi-room building.
